(19) United States
(12) Patent Application Publication
(10) Pub. No.: US 2020/0319362 A1
(43) Pub. Date: Oct. 8, 2020

(54) Non-Invasive Method For Behind-Casing Cable Localization

(71) Applicant: Halliburton Energy Services, Inc., Houston, TX (US)

(72) Inventors: Baris Guner, Houston, TX (US); Kristoffer Thomas Walker, Kingwood, TX (US); Ahmed Elsayed Fouda, Spring, TX (US); Stuart Michael Wood, Kingwood, TX (US)

(73) Assignee: Halliburton Energy Services, Inc., Houston, TX (US)

(21) Appl. No.: 16/777,822

(22) Filed: Jan. 30, 2020

Related U.S. Application Data
(60) Provisional application No. 62/829,149, filed on Apr. 4, 2019.

(51) Int. Cl. G01V 3/10; G01V 3/28

(52) U.S. Cl. CPC G01V 3/104; G01V 3/28

(57) ABSTRACT

A method and system for azimuthal direction detection of a cable. The method may comprise disposing an electromagnetic logging tool into a wellbore, transmitting a primary electromagnetic field from the one or more transmitters, recording one or more secondary electromagnetic fields at the one or more receivers, and identifying a direction to the cable from the one or more secondary electromagnetic fields. The system may comprise one or more transmitters disposed on the electromagnetic logging tool and configured to transmit a primary electromagnetic field. The system may further comprise one or more receivers disposed on the electromagnetic logging tool and configured to record one or more secondary electromagnetic fields. Additionally, the system may further comprise an information handling system configured to identify a direction to an azimuthally localized reduction in metal of the conductor or increase in the metal of the conductor from the secondary electromagnetic fields.

### BACKGROUND

Wellbores drilled into subterranean formations may enable recovery of desirable fluids (e.g., hydrocarbons) using any number of different techniques. During drilling operations, any number of downhole tools may be employed in subterranean operations to determine wellbore and/or formation properties. As wellbores get deeper, downhole tools may become longer and more sophisticated. Measurements taken by downhole tools may provide information that may allow an operator to determine wellbore and/or formation properties.

One tool utilized to determine wellbore and/or formation properties is optical fiber. Optical fiber sensing technology has advanced tremendously during the last twenty years. Interferometric techniques have been coupled with optical fibers, lasers, polarizers, reflectors, photo detectors, and high-speed digital signal processors to enable sensing temperature (DTS), acoustic pressure (DAS), and strain (DSS) along the entire length of standard telecommunication fiber.

Fiber optic cables have been utilized as tools for measurements and may also transport data from downhole tools to the surface. As downhole operations obtain ever greater amounts of data for efficient and thorough job completion, optical fiber telemetry is being implemented in an ever-increasing number of products to provide higher data rate transmission of information and data. Fiber optic cables may be disposed in wellbores through different techniques and in different areas. For example, a fiber optic cable may be disposed in production tubing, within casing, on the outside of the casing, and/or the like. Although environmental concerns regarding flow conveyance have restricted behind-casing fiber to land-based wells, this is becoming a common practice because the benefit of these permanently installed distributed sensors on an as-needed basis.

All of these distributed sensing applications assist in enhancing oil and gas recovery, reducing frequency of well interventions, improving reservoir management strategies, and increasing production yields. Distributed sensing optical fibers are often bundled with other conductor wires in a ruggedized sheath inside cement between the casing and formation. The cement provides protection and good coupling with the formation, permitting distributed sensing to be a cost-effective means by which to time-lapse monitor the temperature, elastic properties, and strain in the vicinity of a borehole. However, they are all dependent on the continuity of an optical fiber. Fibers have considerable tension strength, but very little shear strength. If the fiber breaks, only the fiber up to the break point remains useful. An emerging problem in the oil and gas industry is the accidental breakage of distributed sensing cables through wellbore operations such as perforation operations. This is due to the inability to accurately determine the profile of fiber cables as they traverse down the length of a wellbore.

### BRIEF DESCRIPTION OF THE DRAWINGS

These drawings illustrate certain aspects of some examples of the present disclosure and should not be used to limit or define the disclosure.

FIG. 1 illustrates an example of a well measurement system in which the fiber optic cable is cemented to a casing;

FIG. 2 illustrates an example of a well measurement system in which the fiber optic cable is clamped to the casing;

FIG. 3 illustrates a close-up view of a fiber optic cable in cement;

FIG. 4 illustrates an electromagnetic logging tool disposed in a wellbore;

FIG. 5 is an example of a coil antenna;

FIG. 6 is a graph of filed line of a magnetic dipole;

FIG. 7 illustrates an electromagnetic logging tool configuration for detecting fiber optic cables ins cement;

FIG. 8 illustrates an electromagnetic logging tool with one or more tilted coils for detecting fiber optic cables in cement;

FIG. 9 illustrates a geosignal response when a fiber optic cable is present in a “down” position; and

FIG. 10 illustrates a graph of a geosignal in the fiber optic cable in an “up” and “down” position.

### DETAILED DESCRIPTION

This disclosure may generally relate to systems and methods for well evaluation and, more particularly, embodiments relate to generating a deployment profile of a fiber optic cable as a function of depth and/or distance along a tubular structure. Tubular structures may include an oil well, gas well, completion tubing, casing, pipeline, and/or the like. During location operations, methods may use a principle of active-source, multi-component induction to sense induced secondary currents in conductors inside a conveyance that may also house a fiber optic cable. In examples, one or more fiber optic cables may be bundled with a conductor cable that has sufficient conductivity to be detected above the background noise. A conductive casing and/or mud will produce “secondary currents” that are symmetric around a borehole center, whereas the conductors inside the cable will create “secondary currents” that are asymmetric. This difference in symmetry may be detected to determine the location of the conveyance and thus the fiber optic cable in the borehole. As discussed below, in one example, triaxial transmitter and receiver antennas may be used. These antennas may include three separate coil antennas that can be solenoidally wound in directions that are orthogonal each other. Azimuthal position of the fiber optic cable may be found either through inversion or through a mathematical rotation of the received fields tensor. In a second example, tilted coil antennas may be used for one of the transmitters and/or receivers. These antennas may be located on a rotating platform. By taking multiple samples in the azimuthal direction at a logging depth, the relative azimuthal location of the fiber optic cable may be found by analyzing the strength and polarity of the asymmetric signals. Accurately knowing deployment profile of a fiber optic cable, such as the distance and/or depth of a fiber optic cable may be important during downhole operations. As disclosed below, a non-destructive method for determining the relative position of a fiber optic cable (azimuth and radial distance) in a borehole from behind tubing or casing is described.

Additionally, systems and methods may also be applicable to the detection of the change in the azimuthal conductivity profile due to other reasons as well. As discussed below, determining the change in the azimuthal conductivity profile may allow personnel to determine the location of other downhole devices, such as hydraulic lines, electric cables, tubing encapsulated cables (TEC), tubing, collars, casings, and/or the like. This change in the conductivity profile may occur either due to the presence of additional conductive material or the loss of the conductive material in an azimuthally nonsymmetric manner. Determining the azimuthal direction of the addition or loss of conductive material may allow personnel to determine a direction and angle in relation to the logging tool taking measurements. In operations, metal addition may signal the presence of a conductor. This conductor may be attached to a fiber optic cable, which may identify where the fiber optic cable is located. In examples where TEC systems are used, the addition of metal may identify the location of a tubular holding communication lines, electrical lines, and/or the like. This is true of hydraulic lines and other devices that are conductive or have conductors tied to them. Other examples may include (but are not limited to) locating collars on casings as well as the presence of hardware attached to the casings. This may allow for device location and corrosion detection by detecting an addition or reduction in conducting material.

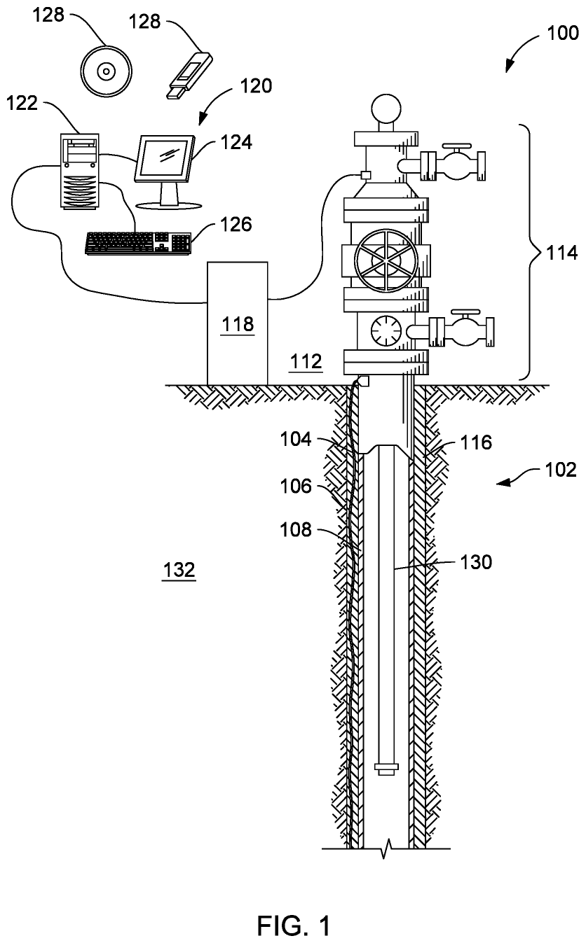

FIG. 1 generally illustrates an example of a well system 100 that may be used in a completed well 102, which may include a fiber optic cable 104. Completed well 102 may be disposed within formation 132. As illustrated, fiber optic cable 104 may be disposed within cement 106 and cement 106 may hold casing 108 in wellbore 116. Additionally, production tubing 130 is disposed in casing 108. As illustrated, completed well 102 may include a series of valves 114 and other apparatuses, which may be used to cap completed well 102. In measurement operations, fiber optic cable 104 may be disposed on the outside of casing 108. For example, fiber optic cable 104 may be cemented to the outside of casing 108. Signal generator/detector 118 may be coupled to fiber optic cable 104 in order to transmit and/or receive a signal downhole. Signal generator/detector 118 may be self-contained and/or coupled to an information handling system 120.

Any suitable technique may be used for transmitting signals from fiber optic cable 104 to surface 112. Systems and methods of the present disclosure may be implemented, at least in part, with information handling system 120. Information handling system 120 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 120 may be a processing unit 122, a network storage device, or any other suitable device and may vary in size, shape, performance, functionality, and price. Information handling system 120 may include random access memory (RAM), one or more processing resources such as a central processing unit (CPU) or hardware or software control logic, ROM, and/or other types of nonvolatile memory. Additional components of the information handling system 120 may include one or more disk drives, one or more network ports for communication with external devices as well as an input device 126 (e.g., keyboard, mouse, etc.) and video display 124. Information handling system 120 may also include one or more buses operable to transmit communications between the various hardware components.

Alternatively, systems and methods of the present disclosure may be implemented, at least in part, with non-transitory computer-readable media 128. Non-transitory computer-readable media 128 may include any instrumentality or aggregation of instrumentalities that may retain data and/or instructions for a period of time. Non-transitory computer-readable media 128 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 120 may be disposed on fiber optic cable 104 or otherwise positioned on surface 112. Information handling system 120 may act as a data acquisition system and possibly a data processing system that analyzes information from fiber optic cable 104. This processing may occur at surface 112 in real-time. Alternatively, the processing may occur at another location after recovery of downhole equipment from wellbore 116 or the processing may be performed by an information handling system 120 in wellbore 116, which may be transmitted in real-time. Alternatively, the processing may occur downhole or a combination of downhole and at surface 112.

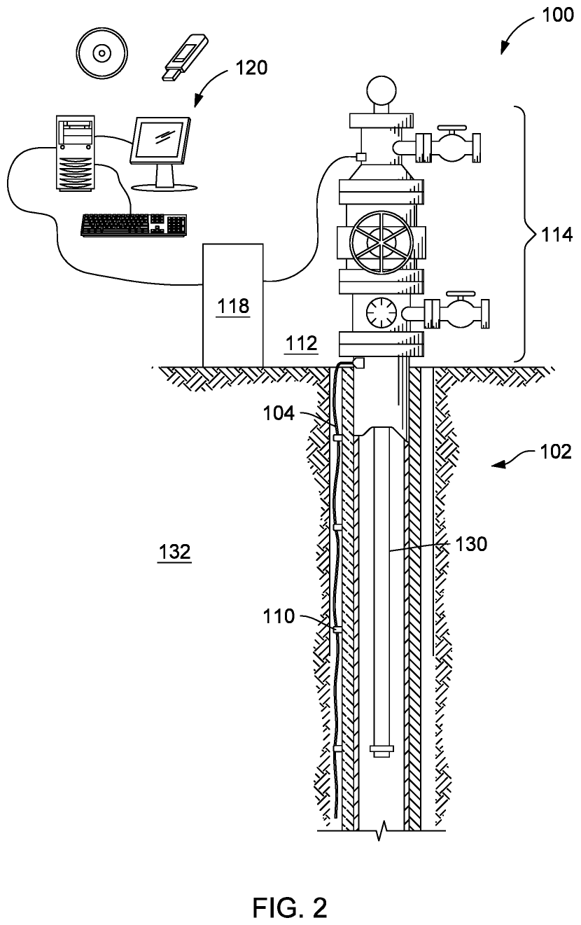

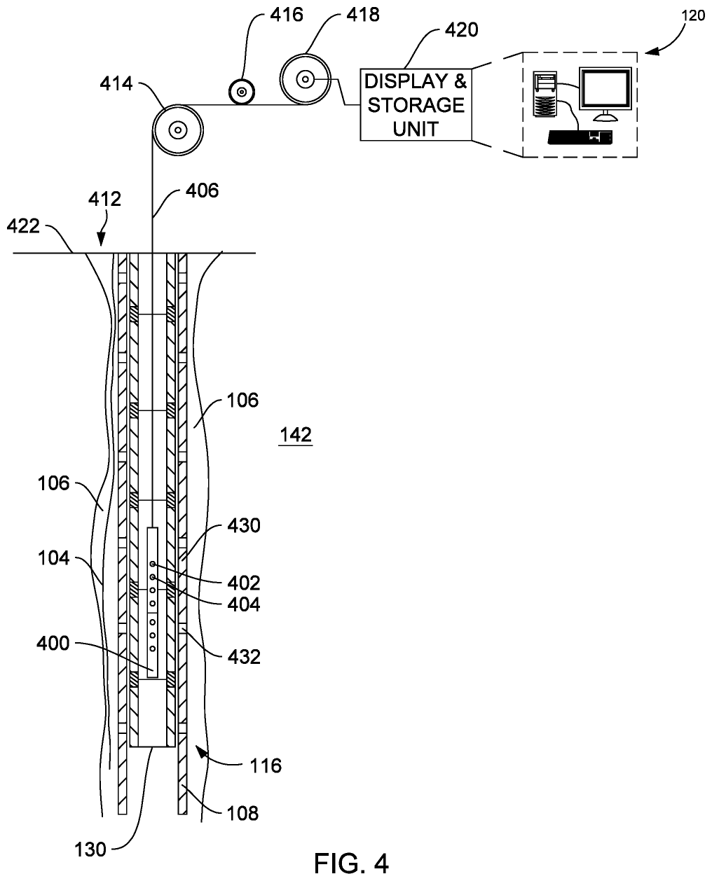

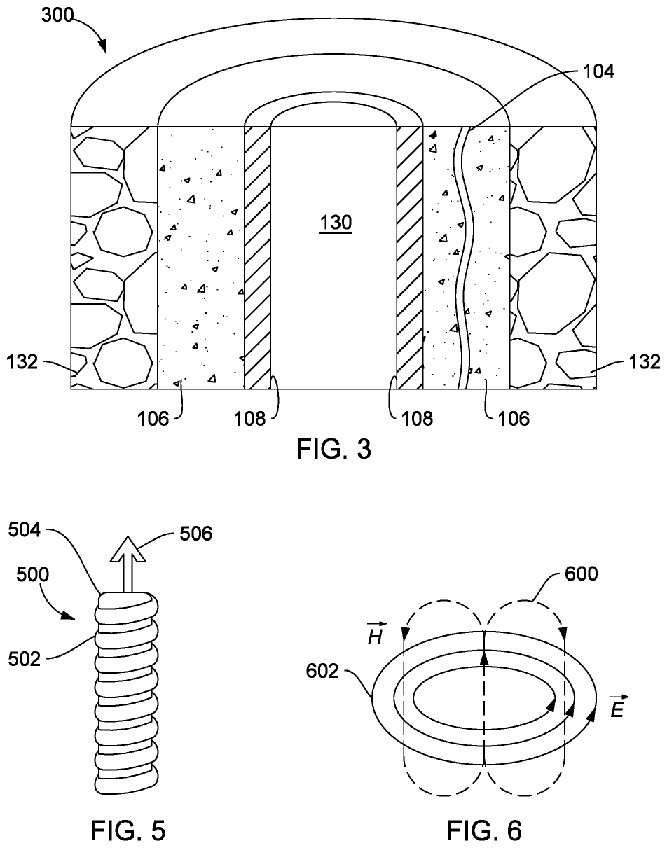

FIG. 2 illustrates a well system 100 that may be used in a completed well 102, in which fiber optic cable 104 may be disposed on the outside of casing 108 within wellbore 116 in accordance with embodiments. In additional examples, the below described methods and systems may be utilized to determine the location of any cable. Thus, a cable or conductor attached to a cable may be used interchangeably with fiber optic cable 104. As illustrated, fiber optic cable 104 may attach to casing 108 through clamps 110 and be encased in cement 106. Although not illustrated, in additional embodiments fiber optic cable 104 may be run within casing 108 and attached to production tubing 130 through clamps 110. Additionally, fiber optic cable 104 may attach to signal generator/detector 118 and/or information handling system 120, which may be disposed at surface 112 and/or on fiber optic cable 104. It should be noted that fiber optic cable 104 may be attached to casing 108 by clamps 110 and then cement 106 may be poured into wellbore 116, which holds casing 108 and fiber optic cable 104 in place. Additionally, FIG. 3 illustrates a cemented-in cable installation 300 of fiber optic cable 104 disposed within cement 106, between casing 108 and formation 132, in accordance with some embodiments. In examples, cement 106 may provide protection to fiber optic cable 104 from external forces.

FIG. 4 illustrates a measurement operation in which an Electromagnetic (“EM”) logging tool 400 is used to determine an azimuthal conductivity profile. The azimuthal conductivity profile include the azimuth and distance of fiber optic cable 104, and as discussed below metal addition or loss, which has been sealed in cement 106 between casing 108 and formation 132, in accordance with some embodiments. EM logging tool 400 may include a transmitter 402 and/or a receiver 404. In examples, EM logging tool 400 may be an induction tool that may operate with continuous wave execution of at least one frequency. This may be performed with any number of transmitters 402 and/or any number of receivers 404, which may be disposed on EM logging tool 400. In examples a single device may operate and function as transmitter 402 and a receiver 404. EM logging tool 400 may be operatively coupled to a conveyance 406 (e.g., wireline, slickline, coiled tubing, pipe, downhole tractor, and/or the like) which may provide mechanical suspension, as well as electrical connectivity, for EM logging tool 400. Conveyance 406 and EM logging tool 400 may extend within casing string 108 to a desired depth within the wellbore 116. Conveyance 406, which may include one or more electrical conductors, may exit wellhead 412, may pass around pulley 414, may engage odometer 416, and may be reeled onto winch 418, which may be employed to raise and lower the tool assembly in wellbore 116. Signals recorded by EM logging tool 400 may be stored on memory and then processed by display and storage unit 420 after recovery of EM logging tool 400 from wellbore 116. Alternatively, signals recorded by EM logging tool 400 may be displayed in situ by way of conveyance 406. As discussed below an information handling system may be used in place of display and storage unit 420 or used in conjunction with display and storage unit 420. Display and storage unit 420 may process the signals, and the information contained therein may be displayed for an operator to observe and stored for future processing and reference. Alternatively, signals may be processed downhole prior to receipt by display and storage unit 420 or both downhole and at surface 422, for example, by display and storage unit 420. Display and storage unit 420 may also contain an apparatus for supplying control signals and power to EM logging tool 400. Typical casing string 108 may extend from wellhead 412 at or above ground level to a selected depth within a wellbore 116. Casing string 108 may include a plurality of joints 430 or segments of casing string 108, each joint 430 being connected to the adjacent segments by a collar 432. It should be noted that there may be any number of layers in casing string 108.

FIG. 4 also illustrates a typical production tubing 130, which may be positioned inside of casing string 108 extending part of the distance down wellbore 116, in accordance with some embodiments. Production tubing 130 may be tubing string, casing string, or other pipe disposed within casing string 108. Production tubing 130 may include concentric pipes. It should be noted that concentric pipes may be connected by collars 432. Although not illustrated, in additional embodiments fiber optic cable 104 may be run within casing 108 and attached to production tubing 130 through clamps 110 (e.g., referring to FIG. 2). EM logging tool 400 may be dimensioned so that it may be lowered into the wellbore 116 through production tubing 130, thus avoiding the difficulty and expense associated with pulling production tubing 130 out of wellbore 116.

In logging systems, such as, for example, logging systems utilizing the EM logging tool 400, a digital telemetry system may be employed, wherein an electrical circuit may be used to both supply power to EM logging tool 400 and to transfer data between display and storage unit 420 and EM logging tool 400. A DC voltage may be provided to EM logging tool 400 by a power supply located above ground level, and data may be coupled to the DC power conductor by a baseband current pulse system. Alternatively, EM logging tool 400 may be powered by batteries located within the downhole tool assembly, and/or the data provided by EM logging tool 400 may be stored within the downhole tool assembly, rather than transmitted to the surface during logging (corrosion detection).

During downhole operations transmitter 402 may transmit electromagnetic fields into formation 132. The electromagnetic fields from transmitter 402 may be referred to as a primary electromagnetic field. The primary electromagnetic fields may produce Eddy Currents in fiber optic cable 104, as discussed below. Eddy Currents are defined as one or more secondary electromagnetic fields. Characterization of fiber optic cable 104, including determination of the azimuth and distance to fiber optic cable 104 from casing 108 may be found.

As illustrated, receivers 404 may be positioned on the EM logging tool 400 at selected distances (e.g., axial spacing) away from transmitters 402. The axial spacing of receivers 404 from transmitters 402 may vary, for example, from about 0 inches (0 cm) to about 40 inches (101.6 cm) or more. It should be understood that the configuration of EM logging tool 400 shown on FIG. 4 is merely illustrative and other configurations of EM logging tool 400 may be used with the present techniques. A spacing of 0 inches (0 cm) may be achieved by collocating coils with different diameters. While FIG. 4 shows only a single array of receivers 404, there may be multiple sensor arrays where the distance between transmitter 402 and receivers 404 in each of the sensor arrays may vary. In addition, EM logging tool 400 may include more than one transmitter 402 and more or less than six of the receivers 404. In addition, transmitter 402 may be a coil implemented for transmission of magnetic field while also measuring EM fields, in some instances. Where multiple transmitters 402 are used, their operation may be multiplexed or time multiplexed. For example, a single transmitter 402 may transmit, for example, a multi-frequency signal or a broadband signal. While not shown, EM logging tool 400 may include a transmitter 402 and receiver 404 that are in the form of coils or solenoids coaxially positioned within a downhole tubular (e.g., casing string 108) and separated along the tool axis. Alternatively, EM logging tool 400 may include a transmitter 402 and receiver 404 that are in the form of coils or solenoids coaxially positioned within a downhole tubular (e.g., casing string 108 or production string 130) and collocated along the tool axis.

There are many different types of antennas that are used for transmitting and receiving electromagnetic (“EM”) waves. FIG. 5 depicts an example of a coil antenna 500. Coil antenna 500 may be constructed by winding a metal 502 (such as copper) wire around a core 504. Following Faraday's Law of Induction, a primary magnetic field that is locally parallel to arrow 506 moving along core 504 may be generated by applying a current through the two terminals of metal 502. Strength of the magnetic field is proportional to the number of turns in coil antenna 500. Magnetic field strength may be further increased by making core 504 from a ferrimagnetic material such as a ferrite.

During ranging operations, using coil antenna 500, coil antenna 500 may be approximated by a magnetic dipole if the distance from coil antenna 500 to an observation point is large compared with the radius of coil antenna 500. A magnetic dipole is generally represented with an arrow (e.g., arrow 506) in the direction of its magnetic moment such as the one shown in FIG. 5. As illustrated in FIG. 6, magnetic dipole field lines 600 can show the direction of the magnetic field at any point in space. Local density of magnetic dipole field lines 600 represent the local strength of the magnetic field. Local density of magnetic dipole field lines 600 is represented by the distance between each magnetic dipole field lines 600. The closer magnetic dipole field lines 600 the denser the magnetic field and the further the magnetic dipole field lines 600 are apart the less dense the magnetic field. As illustrated, two magnetic dipole field lines 600 and electric fields 602 that are coupled to them are illustrated in FIG. 6.

Referring back to FIG. 4, transmission of EM fields by transmitter 402 and the recordation of signals by receivers 404 may be controlled by information handling system 120, in accordance with some embodiments. As illustrated, the information handling system 120 may be a component of the display and storage unit 420. Alternatively, the information handling system 120 may be a component of EM logging tool 400. An information handling system 120 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 120 may be a personal computer, a network storage device, or any other suitable device and may vary in size, shape, performance, functionality, and price.

EM logging tool 400 may use any suitable EM technique based on Eddy current (“EC”) for inspection of concentric pipes (e.g., casing string 108 and production tubing 130). EC techniques may be particularly suited for characterization of a multi-string arrangement in which concentric pipes are used. EC techniques may include, but are not limited to, frequency-domain EC techniques and time-domain EC techniques.

In frequency domain EC techniques, transmitter 402 of EM logging tool 400 may be fed by a continuous sinusoidal signal, producing primary magnetic fields that illuminate the concentric pipes (e.g., casing string 108 and production tubing 130). The primary electromagnetic fields produce Eddy currents in the concentric pipes. These Eddy currents, in turn, produce secondary electromagnetic fields that may be sensed along with the primary electromagnetic fields by receivers 404. Characterization of the concentric pipes may be performed by measuring and processing these electromagnetic fields.

In time domain EC techniques, which may also be referred to as pulsed EC (“PEC”), transmitter 402 may be fed by a pulse. Transient primary electromagnetic fields may be produced due the transition of the pulse from “off” to “on” state or from “on” to “off” state (more common). These transient electromagnetic fields produce EC in the concentric pipes (e.g., casing string 108 and production tubing 130). The EC, in turn, produce secondary electromagnetic fields that may be measured by receivers 404 placed at some distance on EM logging tool 400 from transmitter 402, as shown on FIG. 4. Alternatively, the secondary electromagnetic fields may be measured by a co-located receiver (not shown) or with transmitter 402 itself.

As disclosed below, multi-component induction technology with EM logging tool 400 (e.g., referring to FIG. 4) may be utilized to locate a fiber-optic cable package (fiber optic cable 104 and copper wires bundled together in a ruggedized sheath) behind casing 108 using an active-source. Glass is a main material of fiber optic cable 104, which is non-conductive. Thus, the glass will not create an eddy current in the presence of an electromagnetic field, which may make locating fiber optic cable 104, by itself, in a downhole environment nearly impossible. Wrapping copper wires around the glass material may allow for electromagnetic methods to be utilized to determine the location of the fiber optic cable 104. This is because copper wires may produce an eddy current in the presence of an electromagnetic field. Additionally, the copper wires may add strength to the glass material. With the copper wires, an active source such as transmitter 402, may induce eddy current loops from a magnetic type source. In comparison with galvanic sources, there may not be a direct conduction path between a transmitter 402 and a receiver 404 (e.g., referring to FIG. 4). Rather, currents are induced in loops around the magnetic source, in view of Faraday's law of induction. Strength of the current on a given loop is proportional to the conductivity of the material current travels through as it forms the loop.

In examples, a multicomponent antenna may be constructed by winding three coil antennas 500 (e.g., referring to FIG. 5) and placing them in orthogonal directions (not illustrated). These antennas permit a field to be transmitted or received from any arbitrary direction. In examples, such a system of transmitter/receiver antennas may have a direct coupling. Direct coupling may be defined as a signal originating from the transmitter antenna is well coupled (i.e., received) to the receiver antenna. This “primary” signal dominates the received waveforms making it difficult to see secondary signals produced by induced currents. To eliminate direct coupling, bucking receivers may be used. Bucking receivers may also be multicomponent antennas that are wound in an opposite direction with the receivers. Number of turns and position of the bucking receivers may be adjusted such that the received primary field in air is zero.

The magnetic field response at the receivers (with or without the presence of bucking receivers) for every possible transmitter/receiver combination may be expressed as a 3×3 matrix as shown below,

$${H}^{\overline{\_}} = [ \begin{matrix}{H}_{x x} & {H}_{x y} & {H}_{x z} \\ {H}_{y x} & {H}_{y y} & {H}_{y z} \\ {H}_{z x} & {H}_{z y} & {H}_{zz}\end{matrix} ] \qquad ( 1 )$$

where the first component in the subscript denotes the transmitter direction and the second subscript denotes the receiver direction (i.e., Hxy is the magnetic field received at the y-directed receiver due to an x-directed transmitter.)

FIG. 7 depicts such a multicomponent antenna configuration for EM logging tool 400 for detection of fiber optic cable 104, in accordance with some embodiments. As discussed above, fiber optic cable 104 is attached to and/or connected with a bundle of copper wires. As depicted, during operation an electromagnetic field is generated by transmitter 402. The electromagnetic field may generate an eddy current within the bundle of copper wires. The eddy current \vec{I} that flows along the axis of fiber optic cable 104, generated by transmitter 402, creates an electric field with a component that is tangent to fiber optic cable 104. The eddy current produces a secondary magnetic field (\vec{Hc}) around it, which may be detected by at least one receiver 404. Relative strength of the received signal for each possible component is shown in Equation (1) and may be dependent on the location of receiver 404 with respect to fiber optic cable 104. This sensitivity may be used in an inversion to determine relative azimuth to fiber optic cable 104 from EM logging tool 400. Furthermore, the absolute strength of the received signal is a function of the distances between transmitter 402 and receiver 404, which may be used in an inversion to determine the distance of fiber optic cable 104 from the wall of casing 108.

The proposed inversions find the most likely set of cable azimuth and distances by perturbations to locations until a cost function is minimized. The underlying optimization algorithm may be any one of the commonly used algorithms, including, but not limited to, the steepest descent, conjugate gradient, Gauss-Newton, Levenberg-Marquardt, and Nelder-Mead methods. Although the preceding examples are all conventional iterative algorithms, global approaches such as evolutionary and particle-swarm based algorithms may also be used. In examples, the cost function may be minimized using a linear search over a search vector rather than a sophisticated iterative or global optimization. The linear search, as mentioned earlier, has the advantage of being readily parallelizable and always finds all solutions when multiple solutions exist.

These inversions may be performed at each depth to obtain an azimuth and distance to fiber optic cable 104. It should be noted that quality control metrics including, but not limited to, the ratio of the asymmetric signal maximum amplitude to the symmetric signal amplitude (after adding the effects of the bucking receivers), the width of the cost function in the azimuth and distance domains, and the continuity of the results from one depth to the next may be computed to communicate the reliability of the measured results.

The measured results may be calibrated prior to running inversions to account for any biases that are due to inaccurate assumptions regarding the model or data. Such biases may arise from several factors, including the gain and phase variations of the electronics, temperature and pressure changes, incorrect cable conductivity specifications, etc. Multiplicative coefficients and constant factors may be applied, either together or individually, to the measured log for this calibration.

Other parameters such as cement thickness, mud resistivity, and formation resistivity may be inverted for as well. Alternatively, a priori information may be used in the forward model to account for some of these parameters. It may also be possible to use a multi-frequency and/or multi-spacing system to improve the location accuracy of fiber optic cable 104. An example of the inversion cost function that may use the calibrated measurements is given below. Here it may be assumed that the 3×3 matrix in Equation (1) of V̅ may be converted into a column vector V̅.

$$\begin{matrix}F ( x ) = \frac{1}{2 M} {‖ {W}_{m} \times ( \frac{\vert \overline{S} \vert - \vert \hat{V} \vert}{\vert \hat{V} \vert} ) ‖}_{2}^{2} + \vert {W}_{x} \times {( x - {x}_{nom )} \vert}_{1} & ( 2 ) \\ Cost ( x ) = \frac{1}{2 M} {‖ {W}_{m} \times ( \frac{\vert \overline{S} \vert - \vert \hat{V} \vert}{\vert \hat{V} \vert} ) ‖}_{2}^{2} + \vert {W}_{x} \times {( x - {x}_{nom )} \vert}_{1} & ( 3 )\end{matrix}$$

For the equations above, M is defined as the number of measurements, x is the vector of N unknowns (model parameters) which may include the azimuth and radial distance of fiber optic cable 104 from casing 108, xₙₒₘ is defined as a vector of nominal model parameters, such as those expected based on an adjacent depth, S̅ is defined as a vector of simulated voltages from the assumed forward model used in the inversion, \hat{V} is defined as a vector of measured voltages that have been calibrated. It should be noted that \hat{V} is a function of V̅ that may be expanded as follows:

\hat{V}=α₀+α₁×V̅+α₂×V̅²+ (4)

where α₀, α₁, α₂, . . . are calibration coefficients. Additionally, Wₘ is defined as a measurement weight matrix that is used to assign different weights to different measurements based on an assessment of the relative quality or importance of each measurement, Wₓ is defined as a N×N diagonal matrix of regularization weights, where N is the number of model parameters. Additionally, for any generic N-dimensional vector y may be defined as:

∥y∥²=Σ^{N}|yᵢ|² and |y|1=Σ^{N}|yᵢ| (5)

which are the L2 and L1 norms, respectively. The cost function of Equation (3) above contains two terms: the misfit and the regularization that is used to eliminate spurious non-physical solutions of the inversion problem. Many other norms (other than the 2-norm and 1-norm above) may also be used depending on the desired sensitivity and expected noise levels. In the denominator term, trivial interchanges of the measured and synthetic responses as well as using the absolute value of the difference between \hat{V} and its mean in the denominator terms may also be used.

In addition, to or as an alternative to the model-based inversion, there are two geometric methods for estimating the azimuth to fiber optic cable 104 (e.g., referring to FIG. 7) from EM logging tool 400 (e.g., referring to FIG. 7). To understand these methods, it is useful to understand coordinate system of rotation for EM logging tool 400. For heuristic purposes, wellbore 116 (e.g., referring to FIG. 1) may be assumed to be vertical. The rotation is then about the vertical axis Z by the horizontal azimuth angle Φ. In examples, fiber optic cable 104 may first be identified to see if it may be located at zero azimuth angle (in the X-Z plane). For example, X is along the azimuth, Y is the horizontal perpendicular, and Z is the vertical perpendicular. Equation 1 may then be reduced to follows:

$${{H}^{\overline{\_}}}^{0} = [ \begin{matrix}{H}_{xx}^{0} & 0 & {H}_{x z}^{0} \\ 0 & {H}_{y y}^{0} & 0 \\ {H}_{z x}^{0} & 0 & {H}_{zz}^{0}\end{matrix} ] \qquad ( 6 )$$

Thus, the Hxy, Hyx, Hyz and Hzy components of the coupling matrix become zero. Rotating H̅⁰ by Φ to a new coordinate system where EM logging tool 400 may be located (e.g., referring to FIG. 7), may transform H̅⁰ to:

H̅=R̅^{T}·H̅⁰·R̅ (7)

where the rotation matrix R̅ is:

$${R}^{\overline{\_}} = [ \begin{matrix}cos ( Φ ) & sin ( Φ ) & 0 \\ - sin ( Φ ) & cos ( Φ ) & 0 \\ 0 & 0 & 1\end{matrix} ] \qquad ( 8 )$$

Upon applying Equation (7), receivers 404 are rotated to a new coordinate system where the azimuth to the cable is now Φ, y is perpendicular horizontal, and z is perpendicular vertical:

$$[ \begin{matrix}{H}_{x x} & {H}_{x y} & {H}_{x z} \\ {H}_{y x} & {H}_{y y} & {H}_{y z} \\ {H}_{z x} & {H}_{z y} & {H}_{zz}\end{matrix} ] = [ \begin{matrix}{H}_{x x}^{0} cos {( Φ )}^{2} + {H}_{y y}^{0} sin {( Φ )}^{2} & ( {H}_{x x}^{0} - {H}_{y y}^{0} ) cos ( Φ ) sin ( Φ ) & {H}_{x z}^{0} cos ( Φ ) \\ ( {H}_{x x}^{0} - {H}_{y y}^{0} ) cos ( Φ ) sin ( Φ ) & {H}_{y y}^{0} cos {( Φ )}^{2} + {H}_{x x}^{0} sin {( Φ )}^{2} & {H}_{x z}^{0} sin ( Φ ) \\ {H}_{z x}^{0} cos ( Φ ) & {H}_{z x}^{0} sin ( Φ ) & {H}_{zz}^{0}\end{matrix} ] \qquad ( 9 )$$

The geometry of the situation is that the signal from fiber optic cable 104 (e.g., referring to FIG. 7) is a vector projection onto the X-Y planes. Thus, trigonometric relations may be used to compute the azimuth angle as a function off time sample using any one of the following equations:

$$\begin{matrix}Φ = {tan}^{- 1} ( \frac{{H}_{y z}}{{H}_{xz}} ) & ( 10 ) \\ Φ = {tan}^{- 1} ( \frac{{H}_{z y}}{{H}_{zx}} ) & ( 11 ) \\ Φ = {tan}^{- 1} \frac{( \frac{{H}_{x y} + {H}_{y x}}{{H}_{xx} - {H}_{y y}} )}{2} & ( 12 )\end{matrix}$$

Practical implementation of the above equations may use the signs of the components to determine the quadrant of the azimuth angle and thus eliminate the 180° ambiguity in the angle. This method of angle determination is well known as the “atan2” computation. As a further alternative, Equation (7) using a negated Φ (or the opposite rotation):

H̅⁰=R̅·H̅·R̅^{T} (13)

Equation (13) may be used in an iterative approach to rotate into trial azimuth directions until one has minimized the Hxy, Hyx, Hyz and Hzy components, which happens when the rotation angle equals Φ and the azimuth has been found. In examples, a 3-D rotation over three angles (azimuth and two others) to fully decompose the received signal into its eigenvectors may be performed, thereby maximizing the signal-to-noise ratio along a target axis. However, all of these approaches may be estimates that are based on the assumption that the received cable signal is at a fixed azimuth with respect to axis of EM logging tool 400 (i.e., fiber optic cable 104 may not twist and turn significantly in the volume of investigation of EM logging tool 400. The amount of rotation of fiber optic cable 104 that may be tolerated may be based on the tool accuracy requirements.)

As discussed above, proposed methods and systems are utilized to determine an azimuthal conductivity profile. The azimuthal conductivity profile may determine the azimuthal location and direction to a fiber optic cable, which a conductor has been connected to and/or wound around. The methods and systems describe above may be used to estimate the amount of metal gain or loss in a metallic pipe and an azimuthal location of the metal gain or loss in regard to a logging tool. In examples, azimuthally localized metal gain/loss may be difficult to model. In such examples, an estimate of the overall reduction/increase in metal using an azimuthally symmetric model may be scaled using the directional span of the gain/loss. One example of such a process where an azimuthally symmetric model may be assumed is the remote field eddy current processing technique. In this technique, phase of the measured impedance is assumed to be changing linearly with respect to the total thickness of the pipe. An estimation of the metal gain/loss is produced by measuring the change of the phase of the measurements from a nominal value, and calibrating the metal gain/loss to the change in phase with the assumption that the gain/loss is uniformly distributed around the circumference of the pipe (that is, gain/loss spans 2π radians.) If the directional span is known to be Δϕ radians, then it can be assumed that the actual metal loss is

$$( \frac{2 π}{Δφ} )$$

times that calculated with the azimuthally symmetric assumption.

Directional span of the gain/loss may be calculated, for example, using the analytical methods described above in Equations (6) through (13). For example, the change of the quantity \sqrt{H_{XY}²+H_{YX}²+H_{YZ}²+H_{ZY}²} with azimuth angle may be used for this purpose. This quantity may be denoted as S_{CROSS}(ϕ). If the minimum value of S_{CROSS}(ϕ) over azimuth angle (at a particular logging point) is denoted as MinS and maximum value is denoted as MaxS, the directional span of the gain/loss (Δϕ) may be approximated as the angular difference between two angles around the minimum of S_{CROSS}(ϕ) that satisfies:

$$φ \text{:} {S}_{C R O S S} ( φ ) = ( \frac{Max S + Min S}{2} ) \qquad ( 14 )$$

If more than two angles satisfy the above equation (for example, due to noise,) the two that is closest to the azimuth angle where the minimum (MinS) occurs may be chosen.

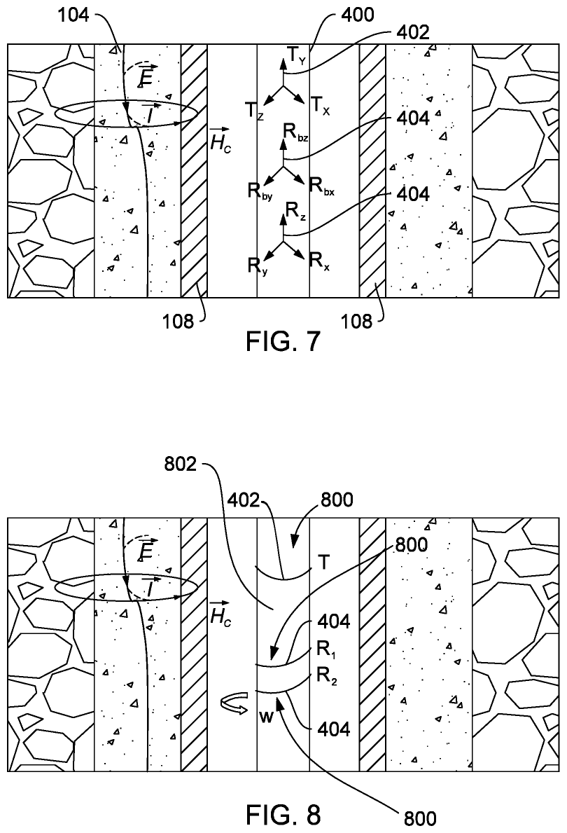

In examples, tilted coils 800 may be used as shown in FIG. 8. In this figure, only receivers 404 may be tilted but in alternative implementations, either receivers 404 or transmitter 402 or both may be tilted. These antennas may be located on a rotating platform 802, which may be at least in part of EM logging tool 400. This platform may be rotated at an angular velocity ω. In practice, it is difficult to maintain a constant angular velocity. In examples, measurements are divided into angular bins and measurements that fall into a certain bin are averaged together to increase signal to noise ratio. Sampling rate should be fast enough to obtain samples whose number is within a desired range in a given bin.

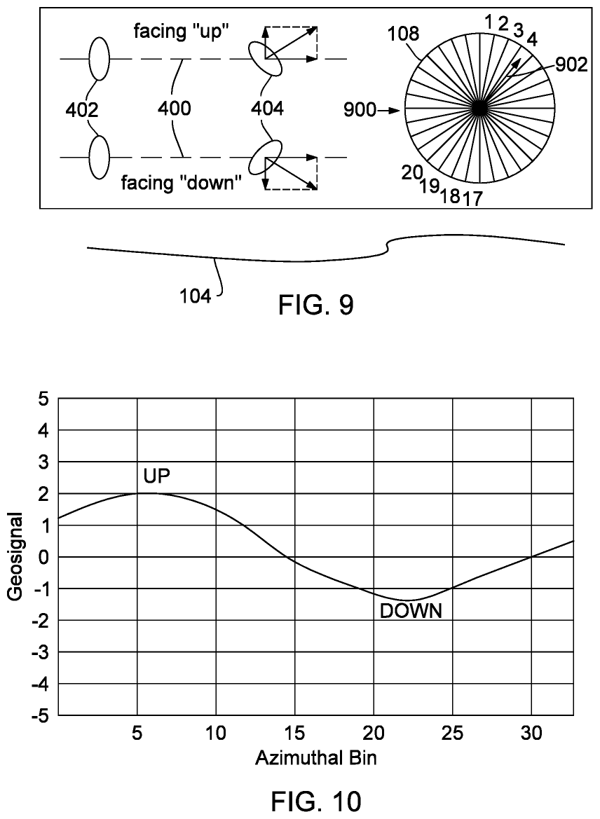

Instead of using bucking receivers, attenuation and phase difference between two sets of receivers 404 (e.g., referring to FIG. 8) may be used in such a system. A so-called “geosignal” may be obtained by subtracting from each bin the measurement from the bin exactly opposite of it (at a 180° angle.). This method is depicted in FIG. 9. As illustrated in FIG. 9, it is common to denote bins as “up” and “down” when using geosignals. This up and down definition is customary and would be with respect to an azimuthal reference on EM logging tool 400. In a homogeneous or symmetric formation, such a geosignal may not change with azimuth. However, if fiber optic cable 104 is present, azimuthal bin 900 may be numbered by a bin. Azimuthal bin 900 is a top down view of casing 108. As illustrated, arrow 902 corresponds to the bin in which the location of fiber optic cable 104 may read the lowest signal. This information is used to form the graph in FIG. 10. In FIG. 10, variation of geosignal when fiber optic cable 104 is in down direction is shown. This method may use a lower number of tilted coils 800 (e.g., referring to FIG. 8) with respect to EM logging tool 400. In examples, EM logging tool of 400 may contain nine or more coil antennas (a triaxial antenna consists of three coil antennas, thus one triaxial transmitter, one triaxial receiver and one triaxial bucking antenna would consist of nine total coil antennas) but EM logging tool 400 may contain as few as three coil antennas. However, a rotating platform may be included with EM logging tool 400 to determine azimuthal sensitivity. Tilted coils 800 may be used to obtain a multicomponent antenna system on a nonrotating platform as well, such a system would be equivalent to the EM logging tool 400 and may include the same number of antennas.

Presented methods and systems provide a fast and continuous way of measuring gain/loss of conductive material. Existing systems may use direct contact with a conductor, which may not be possible for most applications. In other systems, pad type tools that clamp to casing joints are used. These systems are void of either the vertical or the azimuthal resolution to accurately determine location of metal gain/loss with a high accuracy. Current tools are very slow which incurs large rig-time expenses. In other current operations, target conductor may be magnetized or energized from surface, however, this approach may not be always possible or desirable. Acoustic tools may also be used for such purposes, but their large wavelengths significantly reduce their sensitivity and resolution.

Accordingly, the systems and methods disclosed herein may be directed to a method for receiving measurement data from a remote wireline system. The systems and methods may include any of the various features of the systems and methods disclosed herein, including one or more of the following statements.

Statement 1: A method for azimuthal direction detection of a cable may comprise disposing an electromagnetic logging tool into a wellbore, wherein the electromagnetic logging tool comprises. The electromagnetic logging tool may comprise one or more transmitters disposed on the electromagnetic logging tool and one or more receivers disposed on the electromagnetic logging tool. The method may further comprise transmitting a primary electromagnetic field from the one or more transmitters, recording one or more secondary electromagnetic fields at the one or more receivers, and identifying a direction to the cable from the one or more secondary electromagnetic fields.

Statement 2. The method of statement 1, the electromagnetic logging tool comprising one or more bucking antennas configured to remove a primary signal from a secondary signal, wherein the one or more bucking antennas comprise three coil antennas whose magnetic moments are orthogonal to each other.

Statement 3. The method of statements 1 or 2, further comprising calculating a change of a phase and an attenuation of the one or more secondary electromagnetic fields between the one or more receivers.

Statement 4. The method of statements 1-3, further comprising inverting the direction and a distance to the cable using the one or more secondary electromagnetic fields.

Statement 5. The method of statements 1-4, further comprising determining an azimuth angle of the cable from the electromagnetic logging tool as an angle that minimizes xy, yx, yz, and zy components of the one or more secondary electromagnetic fields.

Statement 6. The method of statements 1-5, wherein the cable is a fiber optic cable connected to a conductive material.

Statement 7. A method for azimuthal direction detection of metal may comprise disposing an electromagnetic logging tool into a wellbore. The electromagnetic logging tool may comprise one or more transmitters disposed on the electromagnetic logging tool and one or more receivers disposed on the electromagnetic logging tool. The method may further comprise transmitting a primary electromagnetic field from the one or more transmitters into a conductor, recording one or more secondary electromagnetic fields at the one or more receivers, and identifying a direction to an azimuthally localized reduction in material of the conductor or increase in material of the conductor from the secondary electromagnetic fields.

Statement 8. The method of statement 7, the electromagnetic logging tool comprising one or more bucking antennas configured to remove a primary signal from a secondary signal.

Statement 9. The method of statement 8, wherein the one or more bucking antennas comprise three coil antennas whose magnetic moments are orthogonal to each other.

Statement 10. The method of statements 7 or 8, further comprising calculating a change of a phase and an attenuation of the one or more secondary electromagnetic fields between the one or more receivers.

Statement 11. The method of statements 7, 8, or 10, further comprising inverting the direction and a distance to the azimuthally localized reduction in the metal or increase in the metal using the one or more secondary electromagnetic fields.

Statement 12. The method of statements 7, 8, 10, or 11, further comprising determining an azimuth angle of the reduction in the metal or increase in the metal as an angle that minimizes xy, yx, yz, and zy components of the one or more secondary electromagnetic fields.

Statement 13. The method of statements 7, 8, or 10-12, further comprising calculating a geosignal, wherein the geosignal is calculated at one or more bins corresponding to one or more azimuth angles.

Statement 14. The method of statements 7, 8, or 10-13, further comprising determining corrosion within the conductor based at least in part on the one or more secondary electromagnetic fields.

Statement 15. A directionally sensitive tool may comprise one or more transmitters disposed on an electromagnetic logging tool and configured to transmit a primary electromagnetic field, one or more receivers disposed on the electromagnetic logging tool and configured to record one or more secondary electromagnetic fields and an information handling system configured to identify a direction to an azimuthally localized reduction in metal or increase in the metal from the secondary electromagnetic fields.

Statement 16. The directionally sensitive tool of statement 15, further comprising a rotating platform.

Statement 17. The directionally sensitive tool of statement 16, wherein the one or more transmitters and the one or more receivers are tilted coils disposed on the rotating platform.

Statement 18. The directionally sensitive tool of statements 15 or 16, further comprising one or more bucking antennas, wherein the one or more sets of bucking antennas comprise three coil antennas whose magnetic moments are orthogonal to each other.

Statement 19. The directionally sensitive tool of statements 15, 16 or 18, wherein the one or more transmitters comprise three coil antennas whose magnetic moments are orthogonal to each other.

Statement 20. The directionally sensitive tool of statements 15, 16, 18, or 19, wherein the one or more receivers comprise three coil antennas whose magnetic moments are orthogonal to each other.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method for azimuthal direction detection of a cable comprising:
disposing an electromagnetic logging tool into a wellbore, wherein the electromagnetic logging tool comprises:
one or more transmitters disposed on the electromagnetic logging tool; and
one or more receivers disposed on the electromagnetic logging tool;
transmitting a primary electromagnetic field from the one or more transmitters;
recording one or more secondary electromagnetic fields at the one or more receivers; and
identifying a direction to the cable from the one or more secondary electromagnetic fields.

2. The method of claim 1, the electromagnetic logging tool comprising one or more bucking antennas configured to remove a primary signal from a secondary signal, wherein the one or more bucking antennas comprise three coil antennas whose magnetic moments are orthogonal to each other.

3. The method of claim 1, further comprising calculating a change of a phase and an attenuation of the one or more secondary electromagnetic fields between the one or more receivers.

4. The method of claim 1, further comprising inverting the direction and a distance to the cable using the one or more secondary electromagnetic fields.

5. The method of claim 1, further comprising determining an azimuth angle of the cable from the electromagnetic logging tool as an angle that minimizes xy, yx, yz, and zy components of the one or more secondary electromagnetic fields.

6. The method of claim 1, wherein the cable is a fiber optic cable connected to a conductive material.

7. A method for azimuthal direction detection of metal comprising:
disposing an electromagnetic logging tool into a wellbore, wherein the electromagnetic logging tool comprises:
one or more transmitters disposed on the electromagnetic logging tool; and
one or more receivers disposed on the electromagnetic logging tool;
transmitting a primary electromagnetic field from the one or more transmitters into a conductor;
recording one or more secondary electromagnetic fields at the one or more receivers; and
identifying a direction to an azimuthally localized reduction in material of the conductor or increase in material of the conductor from the secondary electromagnetic fields.

8. The method of claim 7, the electromagnetic logging tool comprising one or more bucking antennas configured to remove a primary signal from a secondary signal.

9. The method of claim 8, wherein the one or more bucking antennas comprise three coil antennas whose magnetic moments are orthogonal to each other.

10. The method of claim 7, further comprising calculating a change of a phase and an attenuation of the one or more secondary electromagnetic fields between the one or more receivers.

11. The method of claim 7, further comprising inverting the direction and a distance to the azimuthally localized reduction in the metal or increase in the metal using the one or more secondary electromagnetic fields.

12. The method of claim 7, further comprising determining an azimuth angle of the reduction in the metal or increase in the metal as an angle that minimizes xy, yx, yz, and zy components of the one or more secondary electromagnetic fields.

13. The method of claim 7, further comprising calculating a geosignal, wherein the geosignal is calculated at one or more bins corresponding to one or more azimuth angles.

14. The method of claim 7, further comprising determining corrosion within the conductor based at least in part on the one or more secondary electromagnetic fields.

15. A directionally sensitive tool comprising:
one or more transmitters disposed on an electromagnetic logging tool and configured to transmit a primary electromagnetic field;
one or more receivers disposed on the electromagnetic logging tool and configured to record one or more secondary electromagnetic fields; and
an information handling system configured to:
identify a direction to an azimuthally localized reduction in metal or increase in the metal from the secondary electromagnetic fields.

16. The directionally sensitive tool of claim 15, further comprising a rotating platform.

17. The directionally sensitive tool of claim 16, wherein the one or more transmitters and the one or more receivers are tilted coils disposed on the rotating platform.

18. The directionally sensitive tool of claim 15, further comprising one or more bucking antennas, wherein the one or more sets of bucking antennas comprise three coil antennas whose magnetic moments are orthogonal to each other.

19. The directionally sensitive tool of claim 15, wherein the one or more transmitters comprise three coil antennas whose magnetic moments are orthogonal to each other.

20. The directionally sensitive tool of claim 15, wherein the one or more receivers comprise three coil antennas whose magnetic moments are orthogonal to each other.
